(19) United States
(12) Patent Application Publication
(10) Pub. No.: US 2024/0308372 A1
(43) Pub. Date: Sep. 19, 2024

(54) Solar Shield 7

(71) Applicant: Marcus Henry Welles, Hampton, GA (US)

(72) Inventor: Marcus Henry Welles, Hampton, GA (US)

(21) Appl. No.: 18/123,306

(22) Filed: Mar. 19, 2023

(51) Int. Cl. B60L 53/51; B60L 8/00; B60L 53/18; B60L 53/20; B60L 53/53; B60L 53/57

(52) U.S. Cl. CPC B60L 53/51; B60L 8/003; B60L 53/18; B60L 53/20; B60L 53/53; B60L 53/57; B60R 11/00; B60R 2011/0026; B60R 2011/0056

(57) ABSTRACT

A system for charging electric vehicles with solar panels inside the car. Making it possible to charge your vehicle any where while the sun is up. Eliminating some of the expense of charging the electric vehicle, and traveling to a charging stations. The solar system can power your house when the power goes out. While at work your car can be charging and when you get off work you car is charged. Plug into the sun.

### BACKGROUND OF THE INVENTION

Using the off grid system of solar power with a combination of components to power an Electric Vehicle. The system is on board and travels with the EV.

Solar Shield 7 is supported with suction cups that attach to the interior of the EV windows.

As the solar panels collect the sunlight they create electricity and pass the electricity through a converter to a solar charging system, which I developed, enabling charging of the electric vehicle any where you go. This eliminates some of the cost of charging the EV, and traveling to a charging station.

### BRIEF SUMMARY OF THE INVENTION

Solar Shield 7 will make charging your Electric Vehicle more cost effective after the purchase of the system. The power charging plant is small and compact. It will only take up a little room in your trunk. The solar panels are flexible, and will store in the back seat or trunk. You will be able to charge your EV anywhere, while the sun is up.

### BRIEF DESCRIPTION OF THE DRAWING FIGURES

FIG. 1 is a perspective view of a car with the Solar Shields 7 installed with and electric vehicle charging cord plugged in, according to an embodiment of the present invention.

FIG. 2 is an interior view of the driver side of the car with the front and rear solar shields installed with wiring and components according to an embodiment of the present invention, with the EV charging cord plugged into the inverter.

FIG. 3 is a top view of the wiring and components to give a better view of the numbering layout and components.

FIG. 4 is Solar Shield 4 for the front windshield, the flexible panels make the panels easy to bend and install, the suction cups hold the panel up to the window, according to an embodiment of the present invention.

FIG. 5 is Solar Shield 5 for the front passenger window, the solar panel attaches to the window with suction cups, according to an embodiment of the present invention.

FIG. 6 is Solar Shield 6 for the rear window passenger side, the converter is on the back side of the solar panels, according to an embodiment of the present invention.

FIG. 7 shows a solar panel with the eyelet exposed, in the lower right corner, this is the opening for the suction cups to be press in, according to an embodiment of the present invention.

FIG. 8 is the back window Solar Shield 8, with the suction cups installed.

FIG. 9 is a electric vehicle charging cable according to an embodiment of the present invention.

FIG. 10 is a flow chart of the main components according to an embodiment of the present invention.

FIG. 11 is a front view of the solar charging system according to an embodiment of the present invention.

FIG. 12 is Solar Shield 12 for the driver side front window. With the suction cups installed, according to an embodiment of the present invention.

FIG. 13 is Solar Shiedl 13 for the driver side back window, with the suction cups installed, according to an embodiment of the present invention.

### DETAILED DESCRIPTION

The inventor provides a unique system for charging electric vehicles with solar panels inside the vehicle. This mobile charging system can be installed when the car is parked. The solar panels are attached to the window with suction cups to hold the solar panels against the car window and absorb the sunlight to the PV cells in the panel. This energy creates electrical charges that move in response to an internal electrical field in the cell causing electricity to flow. The present invention is described in enabling detail in the following examples, which may represent more than one embodiment of the present invention.

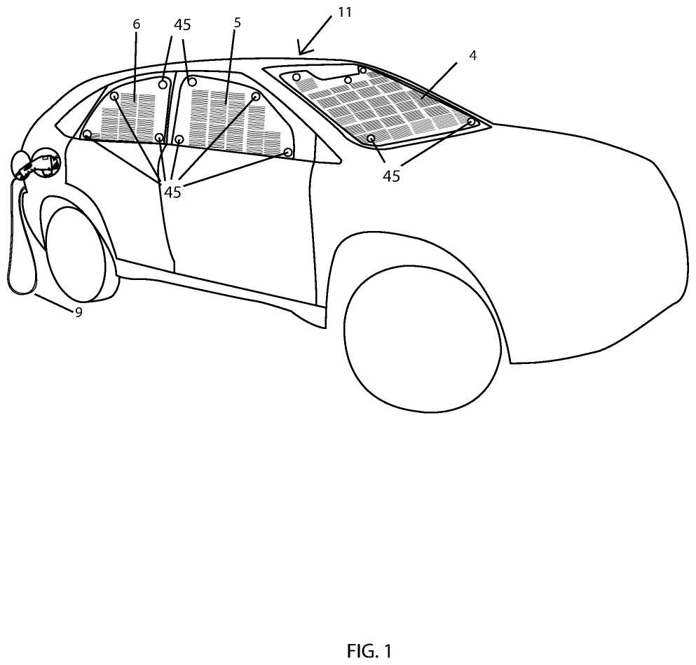

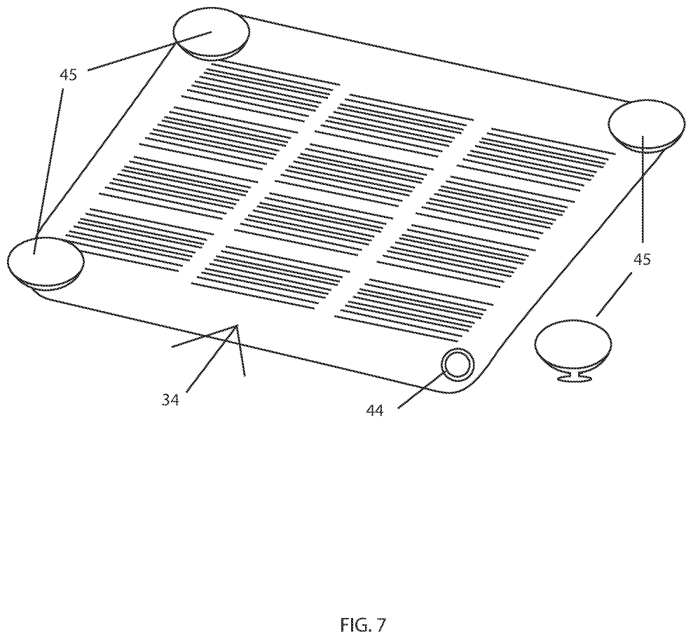

FIG. 1 is a perspective view of a car 11 with a front window Solar Shield panel 4 installed in the car 11, attached with suction cups 45, according to an embodiment of the present invention. In one embodiment a Solar Shield 5 is installed in the car 11, and supported by suction cups 45 according to an embodiment of the present invention. Car 11 in this example has a Solar Shield 6 in the passenger back window, held up by suction cups 45. As illustrated in FIG. 7, according to an embodiment of the present invention. According to an embodiment of the present invention, Car 11 in this example has a electric vehicle charging cable 9 charging the car.

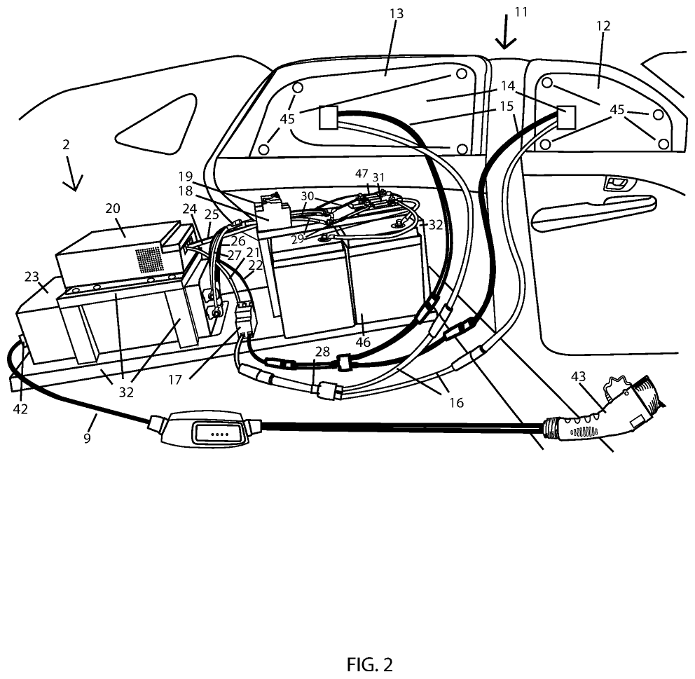

FIG. 2 is inside the car 11 view with the front driver side window, a Solar Shield 12 installed and held up to the window with suction cups 45 as shown in FIG. 7, according to an embodiment of the present invention. When operating, in one embodiment a electric energy converter 14 is charging the negative wire 15 and positive wire 16 and feeding a solar charging system 2 through a circuit breaker 17. Car 11 back driver side window in this example, is a Solar Shield 13 installed and held up to the window with suction cups 45 according to an embodiment of the present invention. Car 11 in this example has a solar charging system 2 that takes the 12 volts DC from the Solar Shields 13 and converts it to 220 volts AC and power an electric vehicle charging cable 9, that plugs into an inverter 23 with a plug 42 that charges the car 11 with a plug 43.

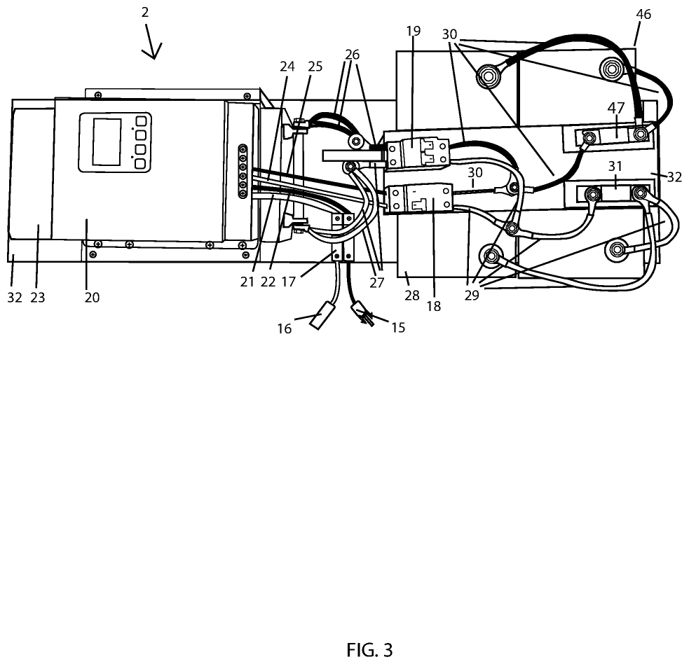

FIG. 3 is a top view of the solar charging system 2 with the wiring and components in this example, a circuit breaker 17 is where the 12 volts DC electricity enters the solar charging system 2 from the Solar Shields, 4, 5, 6, 8, 12 and 13, moving through wire 21 positive and wire 22 negative to a charge controller 20 that manages the electricity.

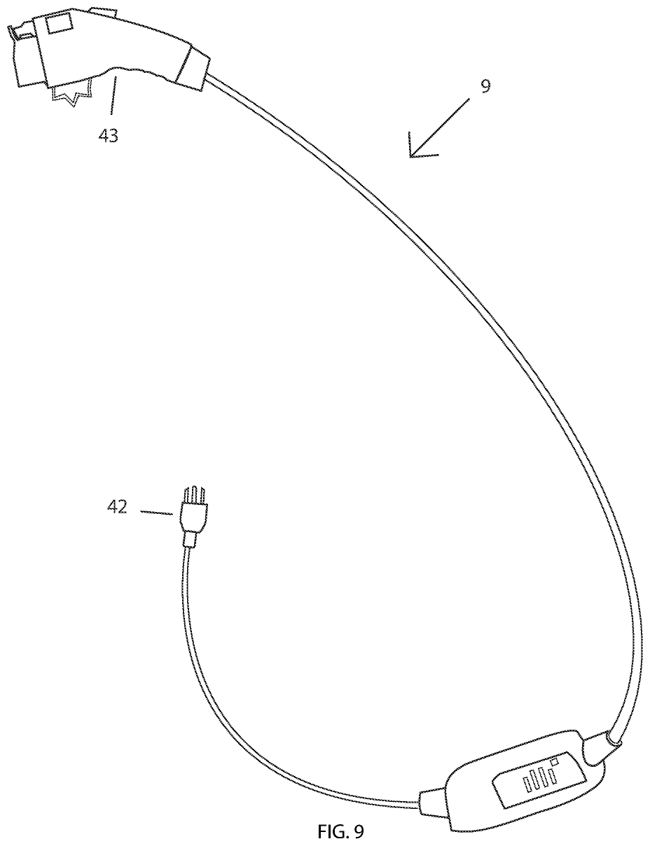

Charge controller 20 sends the electricity out wire 24 positive and wire 25 negative to a circuit breaker 18 to charge a battery 46. Wire 29 positive leaves a circuit breaker 18 to charge a battery 28, and branches off to a circuit breaker 19. Wire 30 negative leaves circuit breaker 18 and charges the battery 46, and branches off to circuit breaker 19. When in operation in one embodiment circuit breaker 19 is the on and off switch for the electricity moving to a inverter 23. Circuit breaker 19 feeds electricity through wires 26 negative to the inverter. Circuit breaker 19 feeds electricity through wires 27 positive to the inverter. The inverter 23 takes the electricity it receives and converts the 12 volts DC to 220 volts AC according to an embodiment of the present invention. In this example a electric vehicle charging cable 9 in FIG. 9 plugs into the inverter 23, and plugs into the car 11 in FIG. 1 according to an embodiment of the present invention. The solar charging system 2 is constructed on a wooden frame 32 in this example.

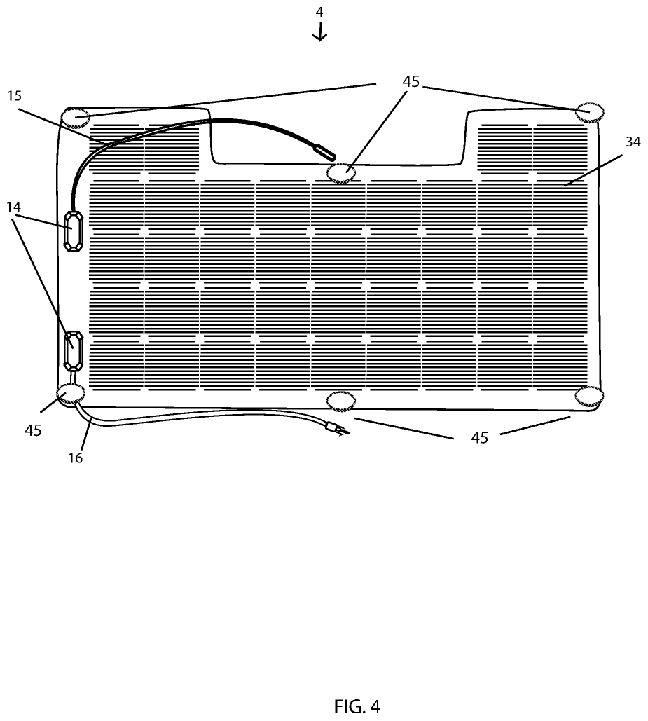

FIG. 4 In this example a front window Solar Shield 4 with suction cups 45 attached in eyelets 44. The suction cups hold the panel against the window to absorb the sun light in this embodiment. When in operation in one embodiment the solar panel 34 converts electricity, with a converter 14 sending electricity to a negative wire 15 and a positive wire 16 to a circuit breaker 17 of the solar charging system 2.

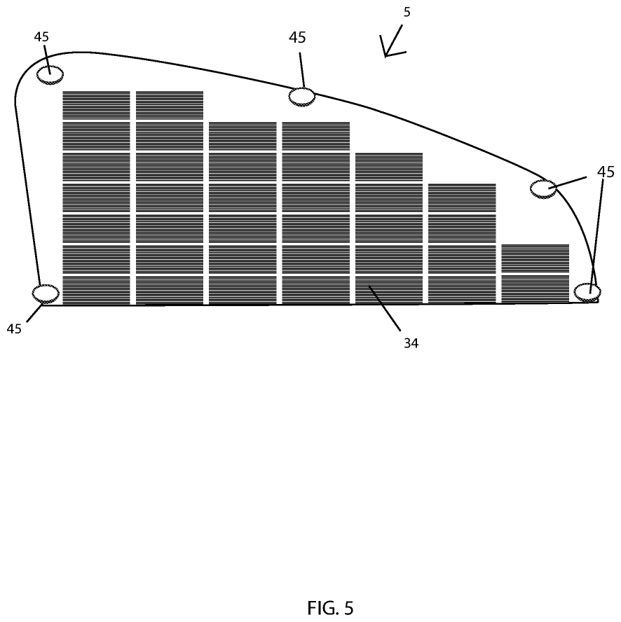

FIG. 5 in this example, a passenger front window Solar Shield 5 with suction cups 45 installed in the eyelets 44. The suction cusp hold the panel against the window to absorb the sunlight and create electricity according to an embodiment of the present invention.

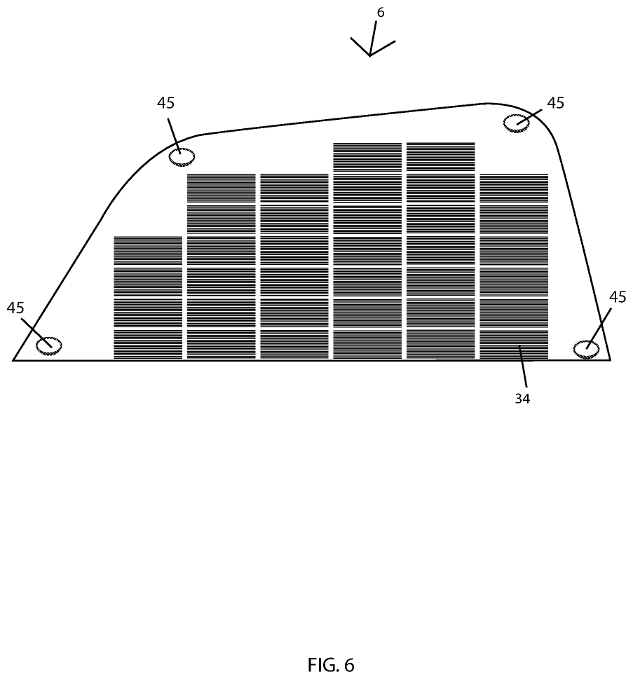

FIG. 6 in this example, a passenger back window Solar Shield 6 with suction cups 45 installed in eyelets 44. The suction cups 45 holds the Solar Shield 6 against the window, to collecting sunlight to create electricity, according to an embodiment of the present invention.

FIG. 7 in this example, shows a solar panel 34 with the eyelet 44 exposed without the suction cusp 45, and the suction cups 45 installed in the solar panel 34 other eyelets 44. The Solar Shields 34 has the convert 14 on the back side, the placement of the convert 14 depending on the manufacturer, according to an embodiment of the present invention.

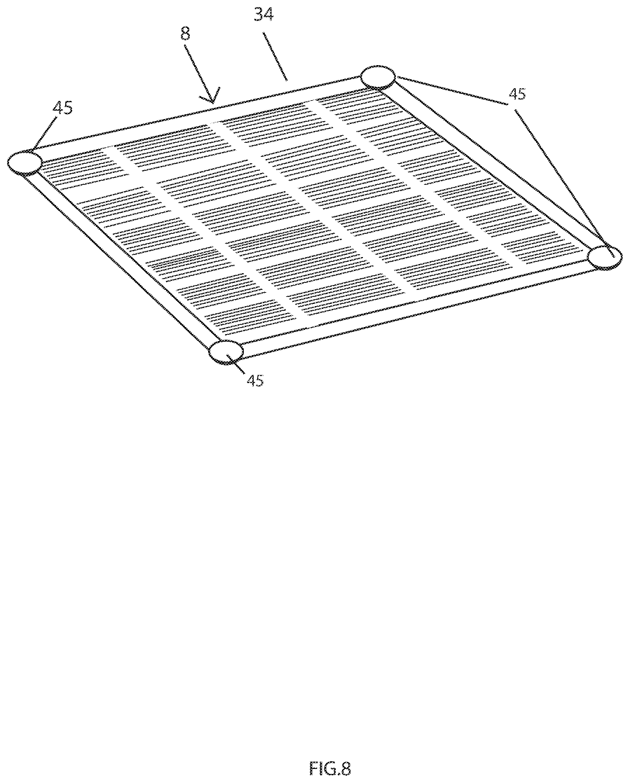

FIG. 8 is a perspective view of the back solar panel, a Solar Shield 8 according to an embodiment of the present invention. The suction cups 45 holds the panel 8 up to the window of the electric vehicle to absorb the sunlight to create electricity, to power the EV in this example.

FIG. 9 in this example 9 is a electric vehicle charging cable, that plugs into the inverter 23 with plug 42 and plug 43 plugs into the car 11 according to an embodiment of the present invention.

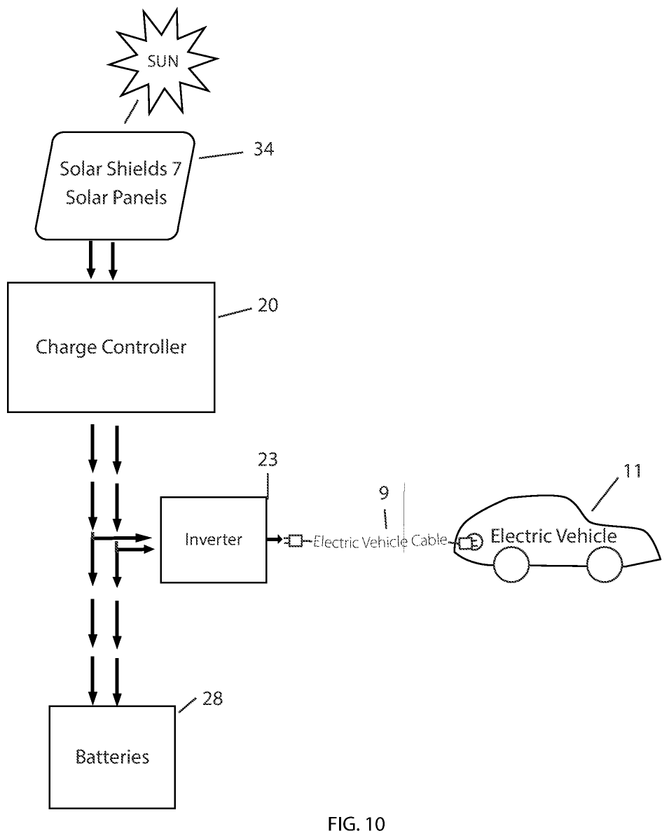

FIG. 10 is a process flow chart illustrating electronic components of the Solar Shield 7, according to another embodiment of the present invention.

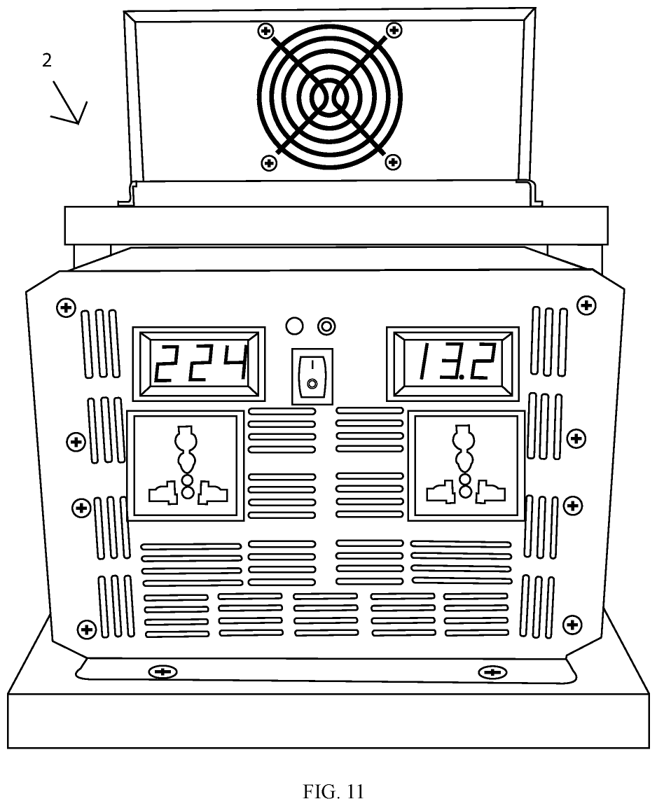

FIG. 11 in this example is a front view of 2 the power plant that makes the electricity to power the electric vehicle, according to an embodiment of the present invention.

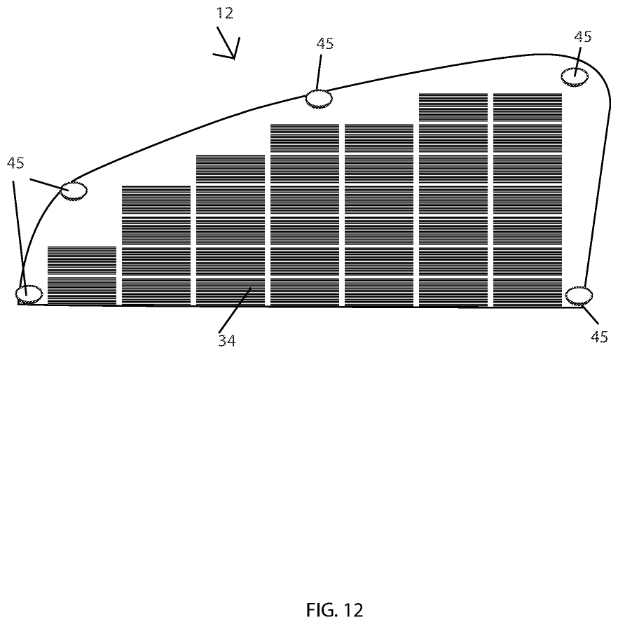

FIG. 12 in this example is a front driver side window, Solar Shield 12 according to an embodiment of the present invention. The suction cups 45 hold the solar panel 34 up to the window to absorb sunlight according to an embodiment of the present invention.

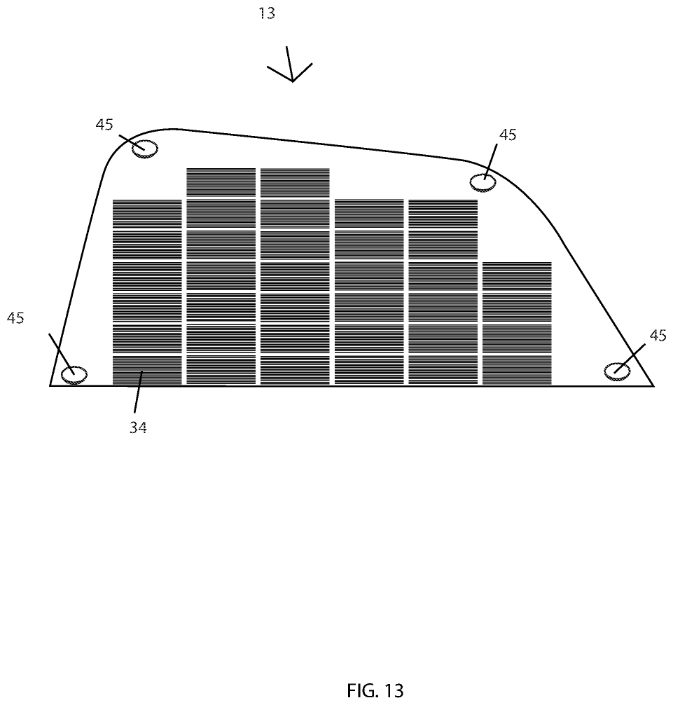

FIG. 13 in this example is a back driver side window Solar Shield 13, according to an embodiment of the present invention. The suction cups 45 hold the solar panel 34 up to the window to absorb the sunlight, according to an embodiment of the present invention.

It will be apparent to one with skill in the art that the Solar Shield 7 invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A system for charging Electric Vehicles with sun light that shines onto a solar panel, the sun light is absorbed by the PV cells in the panel. This energy creates electrical charges that move in response to an internal electrical field in the cell causing electricity to flow, comprising;
a solar panel passes the electricity through a converter to a positive and negative wire, that is wired to a charge controller;
a charge controller accepts the electricity into the inputs for the positive and negative solar panel feed into the charge controller, and manages the electricity for distribution to other components.
a battery bank is connected to the charge controller outputs, positive and negative out going wires feeding electricity to the batteries.
a inverter is connected to the positive and negative wires of the batteries and converts the DC 12 volts current to AC 220 volts;
a electric vehicle charging cable is plugged into the inverter:
a electric vehicle is then plugged into, by the electric vehicle charging cable, and the car is charging by solar power from the sun;

2. The system of claim 1 the solar panels are installed inside of the car.

3. The system of claim 1 the solar panels are attached to the window of the car with suction cups.

4. The system of claim 1 the minimum of suction cups for each panel is four cups.
